(19) United States
(12) Patent Application Publication
(10) Pub. No.: US 2022/0408747 A1
(43) Pub. Date: Dec. 29, 2022

(54) CONTROL OF EYES FORMATION IN SWISS TYPE CHEESE AND CONTINENTAL CHEESE TYPE

(71) Applicant: Chr. Hansen A/S, Hoersholm (DK)

(72) Inventors: Fernanda STREIT, Hoersholm (DK); Sebastien ROUSTEL, Hoersholm (DK); Gregory ROSET, Hoersholm (DK); Remi MAZET, Hoersholm (DK)

(73) Assignee: Chr. Hansen A/S, Hoersholm (DK)

(21) Appl. No.: 17/767,851

(22) PCT Filed: Oct. 9, 2020
(86) PCT No.: PCT/EP2020/078430

§ 371 Date: Apr. 8, 2022

(30) Foreign Application Priority Data
Oct. 10, 2019 (EP) 19202444.6

(51) Int. Cl. A23C 19/068; A23C 19/05; A23C 19/032

(52) U.S. Cl. CPC A23C 19/0688; A23C 19/053; A23C 19/032

(57) ABSTRACT

Present invention relates to new processes for making Swiss cheeses or Continental cheeses type with an improvement of eyes formation and distribution. This present invention relates the culture design and use of particles with defined properties based on technical knowledges about eyes formation. More specifically the present invention relates to a process for making cheese, the process comprising: a. Obtaining a milk composition b. Optionally maturing said milk composition by physical, chemical or biological means c. Adding particles with a size of 1 μm to 50 μm to said milk composition d. Adding lactic acid bacteria and/or proprionic bacteria e. Adding coagulant, wherein steps c, d, and e may be done in random order, sequentially or simultaneously f. and further processing the composition to produce a cheese.

### FIELD OF THE INVENTION

Present invention relates to new processes for making Swiss cheeses or Continental cheeses type with an improvement of eyes formation and distribution. This present invention relates the culture design and use of particles with defined properties based on technical knowledges about eyes formation.

### BACKGROUND

This spatial distribution and size of eyes (or holes) in Swiss- and Continental type cheeses is a crucial quality parameter for producers, retailers and consumers: only small variations are tolerated within the same cheese variety. Eyes formation varies considerable and defects are rather common: defective eye formation, split defect, secondary fermentation, spare eye formation and uneven eye formation.

In modern cheesemaking three main technical steps are being pursued: faster ripening, high salt content and low proteolysis. These parameters contribute in making it more difficult to obtain a correct enough eye formation. (Richoux et al. 1998).

Hence controlling this parameter to optimize the cheese quality is a high priority by cheese manufacturers.

Produced in many countries, the diversity of cheeses with eyes (from Propionic Acid Bacteria: PAB or from Lactic Acid Bacteria: LAB) is wild. We can however devise these cheeses into 2 categories: Swiss cheese type and Continental cheese.

Swiss cheese type meaning cheese where a propionic acid fermentation performed by Propionic Acid Bacteria (PAB). This fermentation leads to characteristic eyes and a nutty and slightly sweet flavor (Frohlich et al. 2017, McSweeney et al. 2017). The body and texture of such cheeses correspond to those of hard or semi-hard cheeses: Emmental cheese according to Codex standard 269-1967 (Codex 2014), semi-hard cheese made with mesophilic culture or a blend of mesophilic and thermophilic culture with PAB: Maasdam, Samsoe, Alpsberg and similar. For the last category, as the technology is based on a cross of Gouda and Emmental, this group is occasionally called “Goutaler” (Abrahamsen et al. 2006).

Continental cheese type with eye formation meaning cheese where hole can be formed without PAB addition but by lactic acid bacteria: mesophilic lactococci and usually leuconostocs, both of which generally produce CO₂. On top, thermophilic culture can be added. This cheese has a semi-soft to semi-hard consistency and a smooth texture, with a few peas sized round holes. The format of the cheese can be a sphere, a flat cylinder or a block. The water content in the fat free cheese (M.N.F.S.) is below 63% and can go to 53%.

In Swiss cheese type, the eyes formation is mainly the result of propionic fermentation during warm room storage, involving the conversion of lactate into propionate, acetate and CO₂. (Frölich-Wyder & Bachmann, 2004; Thierry et al. 2011). Producing propionic cheese with the perfect desired eye formation is a complex process, as there are several technological factors affecting the growth and metabolism of propionic bacteria. The main parameter in propionic acid fermentation is the cell count of the propioni bacteria in the milk. (FIG. 1—Roustel et al. 2018).

The growth of PAB in the cheese is not uniform due to a gradient difference in dry matter, salt, pH and oxygen concentration. The evaluation of the propionic acid fermentation intensity can mainly be represented by propionic acid concentration, depending of the types of cheeses, from 50 to 800 mg/100 g of cheese. Propionic acid fermentation provides a characteristic flavor and eyes formation.

Many technical parameters affect the development of PAB, starting by the strain itself (Richoux et al., 1995). The main influent technical parameters are: milk preparation (bactofugation, milk heat treatment, microfiltration), rheological characteristics of the cheese body (fat in dry matter, fat melting point, moisture, proteolysis, pH and mineralization level), lactic acid bacteria interaction, temperature cycle, salt content and opening nucleation sites. (Guggisberg et al. 2015).

In Swiss cheese type, the process applies a specific maturation step wherein the cheese is stored at between 14° C. to 25° C., where the PAB grows and produce gas to create eyes in the cheese matrix. A variation of 1° C. leads to a 20% variation in growth rate. Before the warm room, a first maturation step (8-12° C.) is important to prepare the texture of the cheese (proteolysis and salt repartition) and after the warm room it is recommended not to store cheeses directly at 4° C. but to lower the temperature step-wise to avoid cracks.

The ripening can be short (3-6 weeks) or longer for some applications. In this cheese the eyes, ranging from scarce to plentiful, should be cherry to walnut size, i.e. ranging from 1 to 5 cm in diameter.

To produce Continental cheese with eyes formation, the culture used are generally a blend of mesophilic culture (lactococci and usually leuconostocs). These both cultures produce CO₂ during the ripening. The ripening is between 2 and 60 weeks at 6 to 15° C. Like for Swiss cheese type, many technical parameters affect the development of bacteria producer of CO₂.

The mechanism of the eyes formation is (FIG. 2):
The level of gas produced by PAB or LAB (for natural ripening, without plastic bag, 30% of the gaze produced is diffused in the atmosphere, 50% are solubilized into the water phase of the cheese and 20% are in the eyes).
The ability of the matrix to open is link with the proteolytic index, the mineralization mainly and some weakness zone.

In many cases, due to the complexity of the eyes formation, it is difficult to have the homogeneous distribution of the eyes in the cheese matrix.

For mechanical reasons, a Fat on Dry Matter (FDM) content greater than 50% will reduce propionic fermentation. This lack of fermentation can also be attributed to higher moisture and higher salt content. On the other-hand, Fat on Dry Matter of less than 45%, is also not ideal for eye formation and can result in cracks in the cheese. Ideally, it is recommended to target an FDM of 47-48%.

This distribution of eyes (spatial distribution) is a crucial quality parameter for producers, retailers and consumers: only small variations are tolerated within the same cheese variety. Eyes formation varies considerable and defects are rather common: defective eye formation, split defect, secondary fermentation, spare eye formation and uneven eye formation.

Different noninvasive methods for image acquisition have been developed and applied for the investigation of eyes formation: X-rays, ultrasounds, and magnetic resonance imaging. (Kraggerud et al. 2009).

Moreover, the process for making Swiss-type cheese and Continental with eyes have changed and evolved because the manner of consuming cheese has changed. With these changes, it is more difficult to obtain the right eyes formation quality in modern Swiss-cheese type and Continental with eyes.

Different technical aspects explain this situation:

Milk quality: producing a milk more and more ‘clean’, natural propionic bacteria are less present. This point is more critical for traditional Swiss-type cheese.

Milk treatment: if filtration and/or bactofugation are efficient for reducing the presence of NSLAB in general and clostridia spores in particularly (Rehn et al. 2011; Rodriguez et al. 2011) and the opposite the milk also contains less and less nuclei particular. Those are crucial for eyes formation, nuclei particulars act like a small micro-ruptures. With CO₂ production during ripening, the presence of nuclei helps eye formation as a rupture point.

The use of solid microparticles (from casein polymerises, curd tannes or caseinate powder) using different size between 0.1 mm and 3.5 mm (FR 2 682 010-A1), seeds like cumin or hay powder (Guggisberg et al. 2015) and microscopic air bubbles (EP-A-181 049) have been proposed and developed. From a general point of view those approaches are not completely satisfying in the sense of the result is even not stable or too delicate to implement in a cheese factory.

### SUMMARY OF THE INVENTION

As disclosed herein, the inventors of present technology have found that by adding particles in defined amounts and sizes, it is possible to control and improve the eyes formation in Swiss- and Continental type cheese.

Further, in a related aspect, the inventors have found that by combining particles of defined sizes with optimized blends of lactic acid bacteria and proprionic bacteria, the eyes formation may be further impacted.

Hence, the present invention provides, in a first aspect, a process for making cheese comprising a step of adding particles to a milk composition comprising lactic acid bacteria and/or proprionibacteria.

Further, the present invention provides, in a related aspect, the composition of these particles to be compatible with the regulatory requirements of cheese production, so they can be used for cheese production.

Further, the present invention provides, in a related aspect, the right dosage between PAB or LAB and the particulate material to control the eyes formation and the spatial distribution of the eyes in the cheese.

More specifically, this present invention is based on a specific mix of PAB and Lactococci or Leuconostocs blend with particulate material (compatible with cheese regulation) to create some nuclei in the cheese matrix to optimise the distribution of eyes and to increase the eyes formation.

With this invention it is now possible to control the interaction between the cheese matrix and the particulate material and the gas-forming bacteria and thereby control the eye formation.

### DETAILED DESCRIPTION OF THE INVENTION

In this present invention, the particles or particulate material is used as nuclei in the cheese matrix.

The particles or particulate material may be produced from milk proteins and milk mineral (described in detail later) hence the addition of the micro-capsular material as disclosed herein will not alter the nutritional characteristics of the cheese.

The size of the particles is controlled and is between 1 to 100 μm and more precisely between 1 and 30 μm. This size of the particulate material may be controlled by controlling the ratio of inorganic phase and the amount of coating material used during the production.

By optimizing the culture compounding and particulate material (type of microorganism, type of micro-capsular organic material and concentration) the distribution, quality and size of eyes formation in Swiss cheese type and Continental cheese with eyes may be controlled as exemplified herein.

Comprised by present invention is also a blend of PAB or Lactococci and Leuconostocs and particulate material, optionally supplied together in a Direct Vat Set (DVS) format.

In an aspect of present invention, the blend of microorganisms (PAB or Lactococci and Leuconostocs) and particulate material is directly added into the milk.

The particulate material will be dispersed into the cheese milk and stay in the cheese matrix to create nuclei. During ripening, the growth of PAB or Lactococci and Leuconostocs and the gas production will be diffused and concentrated in the area of nuclei and create eyes.

The ratio between the level of particulate material content and the PAB or Lactococci and Leuconostocs may be adjusted as disclosed herein to achieve the best eyes formation.

Definitions

All terms and expressions applied herein are intended as having the meaning as generally recognized by the person skilled in the art of making cheese of the Swiss and Continental type.

Lactic acid bacteria (LAB) are an order of gram-positive, low-GC, acid-tolerant, generally nonsporulating, nonrespiring, either rod-shaped (bacilli) or spherical (cocci) bacteria that share common metabolic and physiological characteristics. The genera that comprise the LAB are at its core Lactobacillus, Leuconostoc, Pediococcus, Lactococcus, and Streptococcus. As applied herein, the term lactic acid bacteria are intended to mean lactic acid bacteria recognized as applicable by the skilled cheesemaker when making cheese of the Swiss or Continenal type.

Micellar casein Particles or Particulate material (MCP), is herein defined as spherical or close to spherical bodies with a size between 1 μm to 50 μm. The particulate material (particles) may be prepared and simultaneously (in-situ) coated with polymerized milk proteins. The particles may comprise an inorganic part comprised of a mixture of calcium phosphate (CaP) and calcium carbonate (CaC). The size of the particles may be controlled by formulation of a specific ratio of the inorganic phase and the amount of organic coating polymers in order to achieve a controlled aggregation and obtain particles of size between 1 and 100 μm. The coating may be done using polymerized milk-based proteins to impart colloidal stability and to ensure uniform distribution of the microparticles in the milk/cheese matrix. It may be hypothesized that the CaC in the microparticles will partially dissolve due to acidification, resulting in the formation of carbon dioxide. When saturated, this would act as nuclei for accumulation and growth of carbon dioxide gas produced during ripening of the cheese. A preferred procedure for the preparation of these particles is described below.

Proprionic bacteria or proprionibacterium: Propionibacterium is a gram-positive, anaerobic, rod-shaped genus of bacteria named for their unique metabolism. As applied herein, the term proprionic bacteria is intended to mean bacteria of said genus capable of producing proprionic acid and commonly used for producing cheese of the Swiss type.

### Aspects of the Invention

As disclosed herein the present invention relates to a process for making cheese wherein particulate material is added. Further the present invention relates to use of micro-capsular organic material when making cheese, composition comprising particulate material according to the invention and cheese produced by a process as disclosed herein.

Hence a central aspect of the invention relates to a process for making cheese, the process comprising:
a. Obtaining a milk composition
b. Optionally maturing said milk composition by physical, chemical or biological means
c. Adding particles with a size of 1 μm to 50 μm to said milk composition
d. Adding lactic acid bacteria and/or proprionic bacteria
e. Adding coagulant,

wherein steps c, d, and e may be done in random order, sequentially or simultanously
f. and further processing the composition to produce a cheese.

In present context a person skilled in the art of cheesemaking will know what further processing steps to apply to produce the desired cheese. Alternatively, the processing step are outlined in FIG. 4 and practised in the Examples herein.

The cheese may be a swiss type or continental type cheese and the micro-capsular organic material may be added in an amount of 0.5 g to 5 g per liter milk, such as e.g. 1 g to 3 g per liter milk.

The particles may be added as a dried powder, frozen powder or resuspended powder and the particles may have an average diameter from 1 μm to 50 μm, such as e.g. 3-30 μm, such as e.g. 5 μm.

More specifically, the particles as used in present invention may be selected from a list consisting of: micellar casein, casein glycomacropeptide (CGMP), polymerized casein glycomacropeptide (pCGMP), sodium caseinate or poly caseinate.

The milk composition to which the micro-capsular organic material is added may have a fat content of from 1% to 5%, such as e.g. around 2% to 4%, such as e.g. around 3% and/or a protein content of from 1% to 10%, such as e.g. around 2% to 6%, such as e.g. around 3%

In a further aspect of present invention, the lactic acid bacteria are selected from a list comprising: Lactococcus lactis subsp. Cremoris, Lactococcus lactis subsp lactis, Lactobacillus helveticus, Streptococcus thermophilus and/or proprionic acid bacteria selected from Propionibacterium freudenreichii such as Propionibacterium freudenreichii subsp freudenreichii.

Further, the present invention relates to the use of micro-capsular organic material having an average diameter of 1 μm to 50 μm, such as e.g. 3 μm to 30 μm when making cheese and in particular to control the holes formation when making cheese.

Further, the present invention relates to a composition comprising particulate material according to present invention, lactic acid bacteria and optionally proprionic bacteria, optionally further comprising a coagulant. In a more specific embodiment the lactic acid bacteria comprise Lactococcus lactis subsp. Cremoris, Lactococcus lactis subsp lactis, Lactobacillus helveticus, Streptococcus thermophilus and/or proprionic acid bacteria selected from Propionibacterium freudenreichii such as Propionibacterium freudenreichii subsp freudenreichii.

### DESCRIPTION OF THE FIGURES

FIG. 1: Evolution of different bacteria in a Swiss type cheese over the time

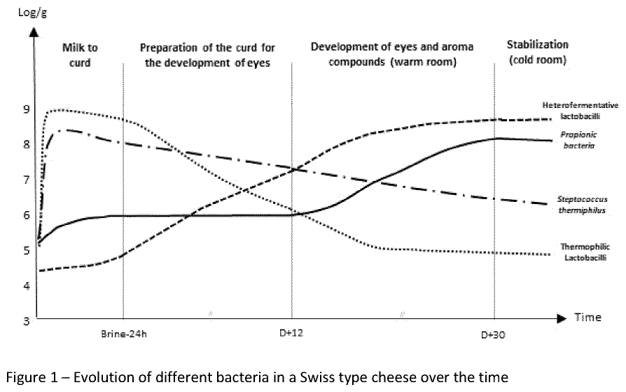

FIG. 2: Mechanism of eyes formation in cheese matrix

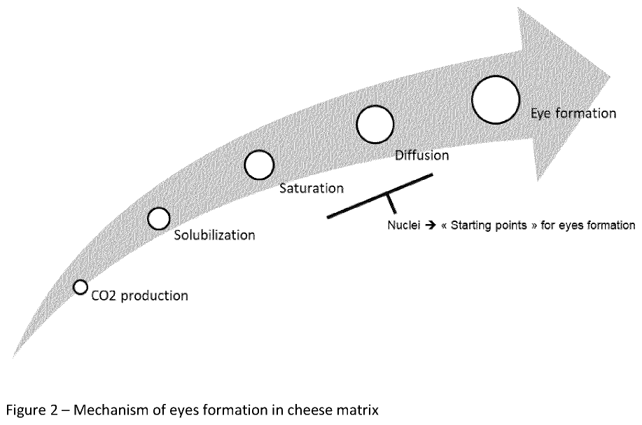

FIG. 3: Microscopic image of the micro-capsular inorganic-organic material (microparticles). The white scale bar at the bottom right side of the image represents a length scale of 20 μm.

FIG. 4: Flow chart to produce Swiss type cheese

FIG. 5—Different area for eye evaluation: in the middle, 5 cm from the middle and 10 cm from the middle

FIG. 6—Eye dispersion in the different part of the cheese: in the middle, 5 cm from the middle and 10 cm from the middle

FIG. 7—Total amount of eyes and size distribution on the different sections of the cheeses produced according to example 1

FIG. 8—Size distribution of MPC 852 B

FIG. 9—Total amount of eyes and size distribution on the different sections of the cheeses produced according to example 2

FIG. 10—Total amount of eyes and size distribution on the different sections of the cheeses produced according to example 3.1

FIG. 11—Total amount of eyes and size distribution on the different sections of the cheeses produced according to example 3.2

FIG. 12—Total amount of eyes and size distribution on the different sections of the cheeses produced according to example 4

FIG. 13—Total amount of eyes and size distribution on the different sections of the cheeses produced according to example 5

FIG. 14—visual representation of eyes and size distribution on the different sections of the cheeses produced according to example 1

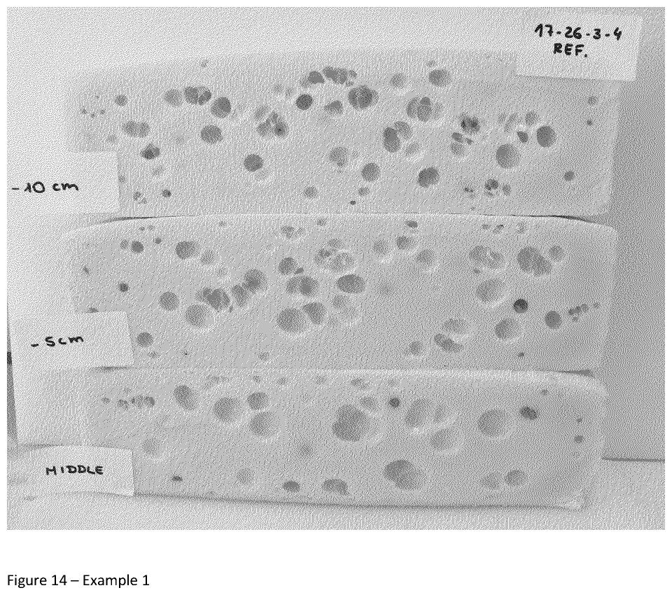

FIG. 15—visual representation of eyes and size distribution on the different sections of the cheeses produced according to example 2

FIG. 16—visual representation of eyes and size distribution on the different sections of the cheeses produced according to example 3.1

FIG. 17—visual representation of eyes and size distribution on the different sections of the cheeses produced according to example 3.2

FIG. 18—visual representation of eyes and size distribution on the different sections of the cheeses produced according to example 4

FIG. 19—visual representation of eyes and size distribution on the different sections of the cheeses produced according to example 5

### EXAMPLES

Examples 1 to 5 were performed in triplicate to increase the robustness of the data.

### Example 1

### Modern Cheesemaking Process for Swiss Type Cheese

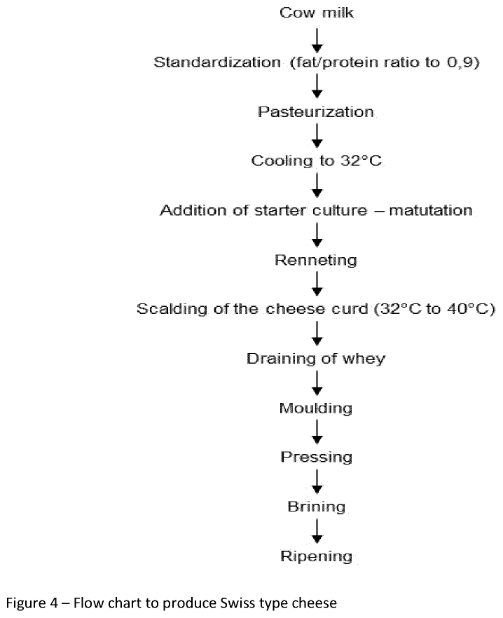

This first example is a modern Propionic cheesemaking process according to the literature and industrial recipes were used (flow charts described in FIG. 4). For this first example, the cultures used were DVS® C150, DVS® LHB02, DVS® STB-01 and DVS® PS60, all from Chr. Hansen® (Denmark). The coagulant was CHY-MAX® Plus from Chr. Hansen® (Denmark).

| Parameters | Example 1 | Example 2 | Example 3.1 | Example 3.2 | Example 4 | Example 5 |
|---|---|---|---|---|---|---|
| Fat content in | 2.92 | 2.92 | 2.92 | 2.92 | 2.92 | 2.92 |
| the milk (%) | | | | | | |
| Protein content | 3.25 | 3.25 | 3.25 | 3.25 | 3.45 | 3.45 |
| in the milk (%) | | | | | | |
| Fat/protein ratio | 0.9 | 0.9 | 0.9 | 0.90 | 0.85 | 0.85 |
| pH at renneting | 6.67 | 6.68 | 6.68 | 6.67 | 6.66 | 6.66 |
| pH of whey off | 6.62 | 6.65 | 6.63 | 6.63 | 6.63 | 6.63 |
| pH end of | 5.35 | 5.34 | 5.36 | 5.36 | 5.44 | 5.44 |
| pressing | | | | | | |
| Cheese size and | 7 kg, square | 7 kg, square | 7 kg, square | 7 kg, square | 7 kg, square | 7 kg, square |
| shape | shape | shape | shape | shape | shape | shape |
| Cultures | DVS ® C150, | DVS ® C150, | DVS ® C150, | DVS ® C150, | DVS ® C150, | DVS ® C150, |
| (type/dosage g | 5 U | 5 U | 5 U | 5 U | 5 U | 5 U |
| per 150 kg of | DVS ® LHB02, | DVS ® LHB02, | DVS ® LHB02, | DVS ® LHB02, | DVS ® LHB02, | DVS ® LHB02, |
| milk) | 0.93 U | 0.93 U | 0.93 U | 0.93 U | 0.93 U | 0.93 U |
| | DVS ® STB-01, | DVS ® STB-01, | DVS ® STB-01, | DVS ® STB-01, | DVS ® STB-01, | DVS ® STB-01, |
| | 2.15 U | 2.15 U | 2.15 U | 2.15 U | 2.15 U | 2.15 U |
| | DVS ® PS60, | DVS ® PS60, | DVS ® PS60, | DVS ® PS60, | DVS ® PS60, | DVS ® PS60, |
| | 3 × 10¹¹ CFU | 3 × 10¹¹ CFU | 3 × 10¹¹ CFU | 3 × 10¹¹ CFU | 3 × 10⁹ CFU | 3 × 10⁹ CFU |
| Coagulant | CHY-MAX ® Plus, | CHY-MAX ® Plus, | CHY-MAX ® Plus, | CHY-MAX ® Plus, | CHY-MAX ® Plus, | CHY-MAX ® Plus, |
| (type/dosage in | 110 IMCU/100 g | 110 IMCU/100 g | 110 IMCU/100 g | 110 IMCU/100 g | 110 IMCU/100 g | 110 IMCU/100 g |
| IMCU/100 kg of | of protein | of protein | of protein | of protein | of protein | of protein |
| milk) | | | | | | |
| Nuclei | None | MPC | Particles size | Particles | Particles | Particles |
| (type/dosage) | | (particles | between 3 | size: 1 μm/ | size: 5 μm/ | size: 5 μm/ |
| | | size around | and 30 μm/ | 2 g/100 L | 1 g/100 L | 2 g/100 L |
| | | 50 μm)/ | 2 g/100 L | | | |
| | | 1 g/100 L | | | | |

The dosage of the coagulant was 110 IMCU/100 g of protein. The culture's dosage applied for 150 kg of milk are, respectively, 5 U, 0.93 U, 2.15 U and 3×10¹¹ CFU. The milk composition is shows in the Table 1 above.

The maturation (from the culture add until cutting) step was 70 min at 32° C. and after that the curd was cut in 5 mm cubes. After cutting, the curd was pre-stirred for 5 minutes before whey off (−35%) and the stirring continue for 20 min before scalding at 40° C. The scalding took 20 min and after the curd was stirred for 40 min before pre-pressing step starts. The pH of the curd at whey-off was between 6.60 and 6.65. After pre-pressing, the curd was moulded into 2 square cheeses of 7 kg each, followed by 3 pressing steps: 10 min at 2 bars, 20 min at 3.5 bar and 80 min at 5 bars. The pH at the end of the pressing was 5.35 (±0.02). The cheeses were brined during 16 hs in a brine containing 22% of salt and pH 5.2, with a salt-in-moisture target of 3%. After brining, the cheeses were packed in plastic bags (Sealed Air—68 μm—BB6050) and were transferred to the ripening rooms and followed a precise ripening cycle: 1 week at 9° C., 4 weeks at 20° C. (warm room), 4 weeks at 9° C., finishing at 5° C.

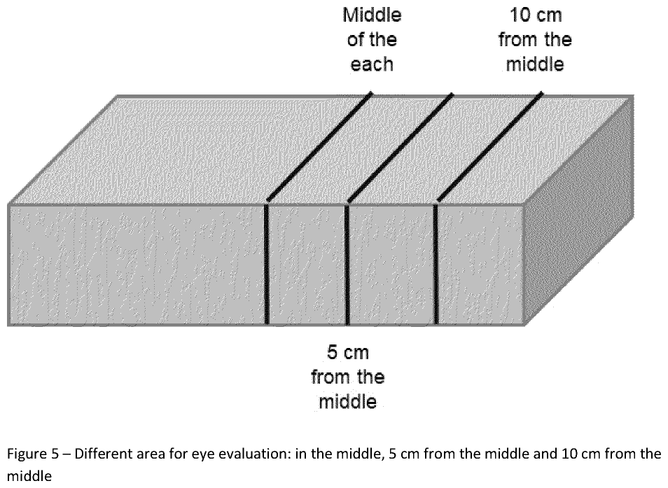

After the warm room, the cheeses were opened and analysed for overall composition (fat, protein, salt, pH), organic acids concentrations, as well eyes formation quality and distribution (visual evaluation, with measurement). To analyse the distribution of the eyes formation in the cheeses, the cheeses were opened precisely in the middle, 5 cm from the middle and 10 cm from the middle (FIG. 5).

With this example 1, the composition of the final cheeses is presented in Table 2 below.

| Cheese composition | Exemple 1 | Exemple 2 | Exemple 3.1 | Exemple 3.2 | Example 4 | Example 5 |
|---|---|---|---|---|---|---|
| Fat (%) | 28.5 ± | 28.9 ± | 28.72 ± | 28.115 ± | 28.06 ± | 27.66 ± |
| | 0.04 | 0.04 | 0.10 | 0.05 | 0.01 | 0.01 |
| Fat in dry matter | 48.8 ± | 49.1 ± | 48.85 ± | 48.66 ± | 47.21 ± | 47.21 ± |
| (FDM, %) | 0.13 | 0.06 | 0.13 | 0.01 | 0.15 | 0.04 |
| Moisture in no fat | 58.3 ± | 57.9 ± | 57.82 ± | 58.73 ± | 56.39 ± | 57.24 ± |
| substrate (MNFS, %) | 0.13 | 0.01 | 0.02 | 0.06 | 0.28 | 0.03 |
| Moisture (% | 41.7 ± | 41.1 ± | 41.22 ± | 42.22 ± | 40.57 ± | 41.41 ± |
| | 0.06 | 0.01 | 0.04 | 0.08 | 0.21 | 0.01 |
| Protein (%) | 25.7 ± | 26.2 ± | 26.065 ± | 25.5 ± | 27.57 ± | 26.98 ± |
| | 0.04 | 0.13 | 0.05 | 0.03 | 0.01 | 0.08 |
| Salt (%) | 1.41 ± | 1.20 ± | 1.29 ± | 1.45 ± | 1.25 ± | 1.305 ± |
| | 0.005 | 0.007 | 0.001 | 0.002 | 0.001 | 0.005 |
| Salt in moisture | 3.37 ± | 2.87 ± | 3.13 ± | 3.42 ± | 3.09 ± | 3.15 ± |
| (SM, %) | 0.05 | 0.05 | 0.05 | 0.05 | 0.05 | 0.05 |
| Lactic acid (mg/g) | <0.2 | <0.2 | <0.2 | 0.6 | <0.2 | <0.2 |
| Propionic acid (mg/g) | 5.00 ± | 5.85 ± | 5.95 ± | 4.95 ± | 2.57 ± | 2.78 ± |
| | 0.30 | 0.05 | 0.05 | 0.05 | 0.03 | 0.29 |
| Acetic acid (mg/g) | 2.55 ± | 3.00 ± | 3.05 ± | 2.45 ± | 1.27 ± | 1.37 ± |
| | 0.15 | 0.00 | 0.05 | 0.05 | 0.02 | 0.15 |
| Succinic acid (mg/g) | 1.75 ± | 2.2 ± | 2.1 ± | 1.8 ± | 0.80 ± | 0.91 ± |
| | 0.05 | 0.00 | 0.00 | 0.00 | 0.04 | 0.08 |

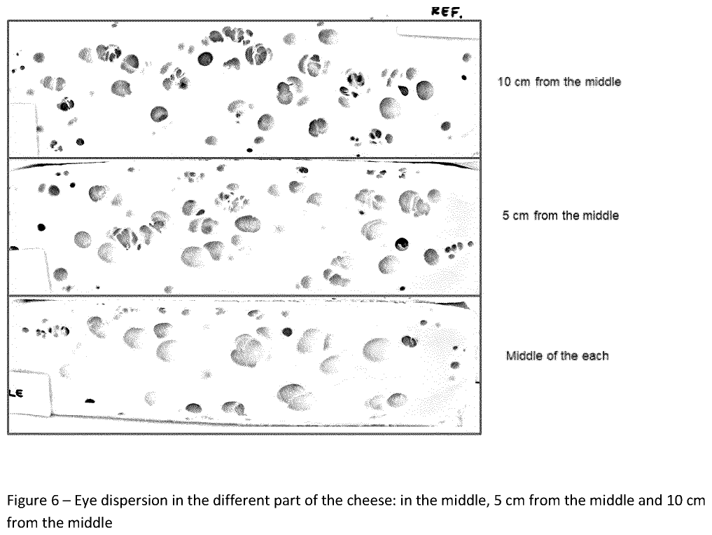

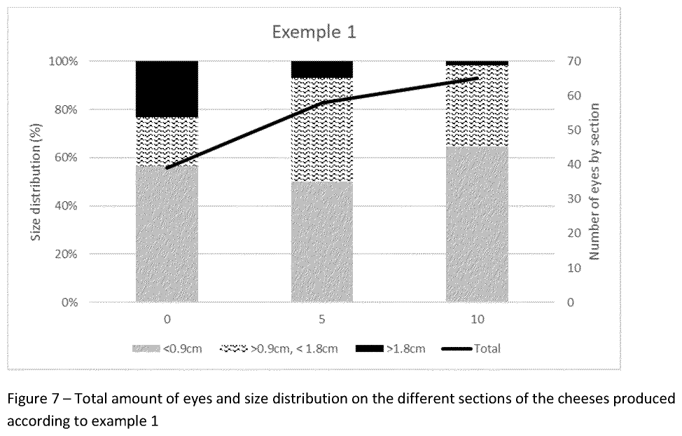

The distribution of the eyes formation (according to the different positions presented on FIG. 5) is presented on FIGS. 6 and 7. On each region of the cheese, the total number of eyes was counted, as well classified in 3 categories: eyes bigger than 1.8 cm, eyes between 0.9 and 1.8 cm and eyes smaller than 0.9 cm.

In this example, the total number of eyes formed increased from the center of the cheese to the outside of the cheese. This increase was correlated to a reduction on the visual quality of the eyes, which means, higher number of eyes with as smaller size and more agglomerated (not individual eyes).

These results confirm that having good eyes distribution, with a good size and visually beautiful is a big issue on modern propionic cheeses.

### Example 2

### Modern Cheesemaking Process for Propionic Cheeses Using MPC to Improve Eyes Formation

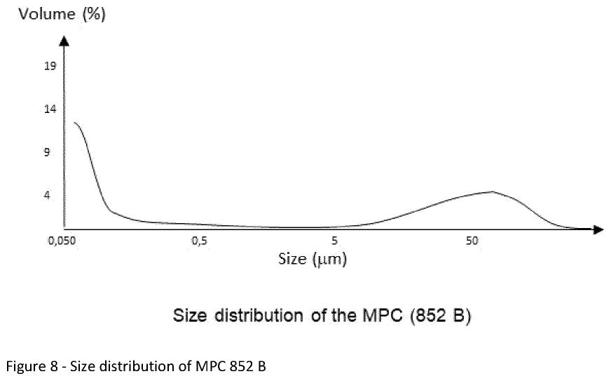

This second example is a modern Propionic cheesemaking process according to the literature and industrial recipes were used (flow charts described in FIG. 4). For this example, the cultures used were DVS® C150, DVS® LHB02, DVS® STB-01 and DVS® PS60, all from Chr. Hansen® (Denmark). The coagulant was CHY-MAX® Plus from Chr. Hansen® (Denmark). The dosage of the coagulant was 110 IMCU/100 g of protein. The culture's dosage applied for 150 kg of milk are, respectively, 5 U, 0.93 U, 2.15 U and 3×10¹¹ CFU. The milk composition is shows in the Table 1. In this case, 1 g of micellar casein MPC 8526 (Ingredia™) was added by 100 L of milk, at the same moment as the cultures. The size distribution of these particles is presented in FIG. 8.

The maturation (from the culture add until cutting) step was 70 min at 32° C. and after that the curd was cut in 5 mm cubes. After cutting, the curd was pre-stirred for 5 minutes before whey off (−35%) and the stirring continue for 20 min before scalding at 40° C. The scalding took 20 min and after the curd was stirred for 40 min before pre-pressing step starts. The pH of the curd at whey-off was 6.65. After pre-pressing, the curd was moulded into 2 square cheeses of 7 kg each, followed by 3 pressing steps: 10 min at 2 bars, 20 min at 3.5 bar and 80 min at 5 bars. The pH at the end of the pressing was 5.34 (±0.02). The cheeses were brined during 16 hs in a brine containing 22% of salt and pH 5.2, with a salt-in-moisture target of 3%. After brining, the cheeses were packed in plastic bags (Sealed Air—68 μm—BB6050) and were transferred to the ripening rooms and followed a precise ripening cycle: 1 week at 9° C., 4 weeks at 20° C. (warm room), 4 weeks at 9° C., finishing at 5° C.

After the warm room, the cheeses were opened and analysed for overall composition (fat, protein, salt, pH), organic acids concentrations, as well eyes formation quality and distribution (visual evaluation, with measurement). To analyse the distribution of the eyes formation in the cheeses, the cheeses were opened precisely in the middle, 5 cm from the middle and 10 cm from the middle (FIG. 5).

With this example 2, the composition of the final cheeses is presented on Table 2.

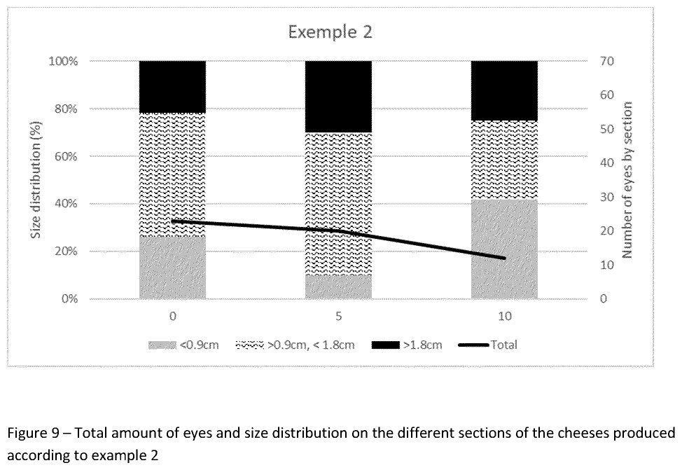

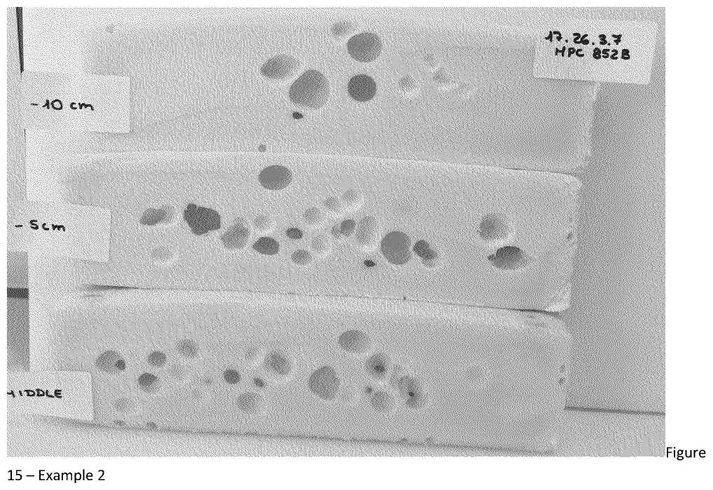

The distribution of the eyes formation is presented on FIG. 9 and FIG. 15. On each region of the cheese, the total number of eyes was counted, as well classified in 3 categories: eyes bigger than 1.8 cm, eyes between 0.9 and 1.8 cm and eyes smaller than 0.9 cm.

In this example, the total number of eyes formed is much smaller compared to example 1, and the amount decrease from the center of the cheese to the outside of the cheese. This decrease was correlated to a reduction on the visual quality of the eyes, which means, higher number of eyes with smaller size and more agglomerated.

These second results confirm that the use of MPC is not a good solution to improve the distribution of the eyes formation in the slices of the cheeses, as well the uniformity of size.

### Example 3

### Modern Cheesemaking Process for Propionic Cheeses Using Controlled Particle Sizes to Improve Eyes Formation

This third example is a modern Propionic cheesemaking process according to the literature and industrial recipes were used (flow charts described in FIG. 4). For this example, the cultures used were DVS® C150, DVS® LHB02, DVS® STB-01 and DVS® PS60, all from Chr. Hansen® (Denmark). The coagulant was CHY-MAX® Plus from Chr. Hansen® (Denmark). The dosage of the coagulant was 110 IMCU/100 g of protein. The culture's dosage applied for 150 kg of milk are, respectively, 5 U, 0.93 U, 2.15 U and 3×10¹¹ CFU. The milk composition is shows in the Table 1. In the example 3.1, 2 g of particles with size between 3 to 30 μm (Chr. Hansen®) were added by 100 L of milk, at the same moment as the cultures. In the example 3.2, 2 g of particles with size of 1 μm (Chr. Hansen®) were added by 100 L of milk, at the same moment as the cultures.

The maturation (from the culture add until cutting) step was 70 min at 32° C. and after that the curd was cut in 5 mm cubes. After cutting, the curd was pre-stirred for 5 minutes before whey off (−35%) and the stirring continue for 20 min before scalding at 40° C. The scalding took 20 min and after the curd was stirred for 40 min before pre-pressing step starts. The pH of the curd at whey-off was 6.63.

After pre-pressing, the curd was moulded into 2 square cheeses of 7kg each, followed by 3 pressing steps: 10 min at 2 bars, 20min at 3,5 bar and 80min at 5 bars. The pH at the end of the pressing was 5.36 (±0.02). The cheeses were brined during 16hs in a brine containing 22% of salt and pH 5.2, with a salt-in-moisture target of 3%. After brining, the cheeses were packed in plastic bags (Sealed Air — 68 pm — BB6050) and were transferred to the ripening rooms and followed a precise ripening cycle: 1 week at 9° C., 4 weeks at 20° C. (warm room), 4 weeks at 9° C., finishing at 5° C.

After the warm room, the cheeses were opened and analysed for overall composition (fat, protein, salt, pH), organic acids concentrations, as well eyes formation quality and distribution (visual evaluation, with measurement). To analyse the distribution of the eyes formation in the cheeses, the cheeses were opened precisely in the middle, 5 cm from the middle and 10 cm from the middle (FIG. 5).

With these examples 3.1 and 3.2, the composition of the final cheeses is presented on Table 2.

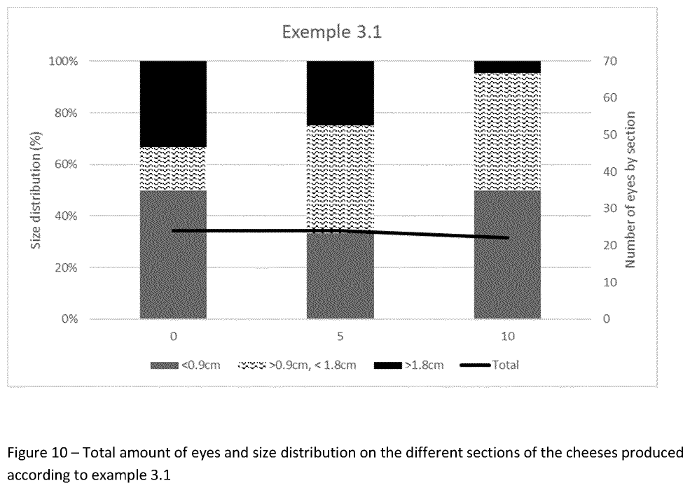

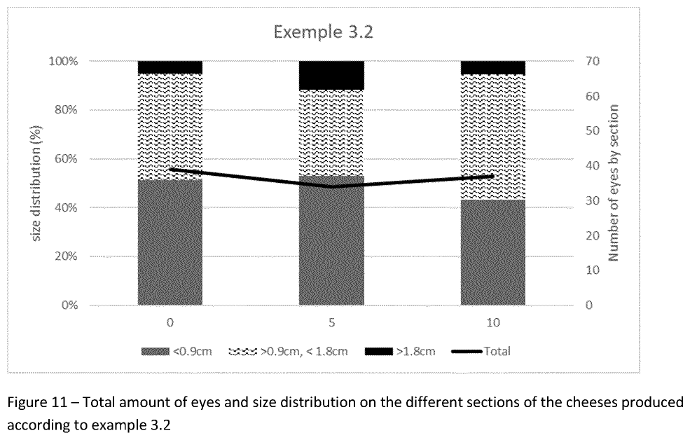

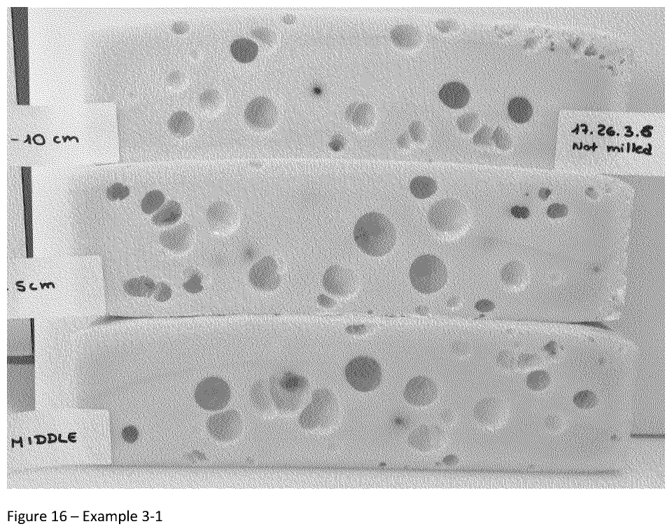

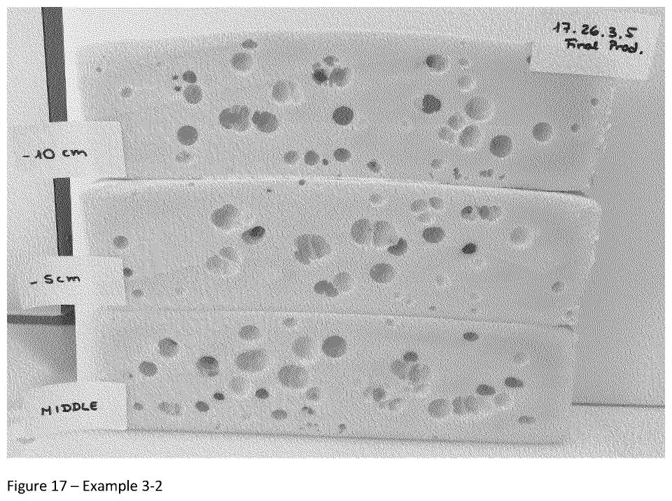

The distribution of the eyes formation is presented on FIG. 10 and FIG. 16 (example 3.1) and FIG. 11 and FIG. 17 (example 3.2). On each region of the cheese, the total number of eyes was counted, as well classified in 3 categories: eyes bigger than 1.8 cm, eyes between 0.9 and 1.8 cm and eyes smaller than 0.9 cm.

In the example 3.1, the total number of eyes formed is homogeneous on the different sections (around 24 by section), but with a different profile of size on each section. This was correlated to the heterogeneity on the particle sizes of the sample used (between 3 and 30 μm). In the example 3.2, the total number of eyes formed is higher than in the example 3.1 (around 35 by section), with a more homogeneous profile size on each section. This was correlate to better homogeneity of the particles size added (1 μm) and a higher number of particles for the same amount added.

This example confirms the importance of the size homogeneity of the particles added to improve the quality of the eyes formation.

### Example 4

### Modern Cheesemaking Process for Propionic Cheeses Using Low Concentration of Controlled Particle Sizes to Improve Eyes Formation

This fourth example is a modern Propionic cheesemake. A process according to the literature and industrial recipes were used (flow charts described in FIG. 4). For this example, the cultures used were DVS® C150, DVS® LHB02, DVS® STB-01 and DVS® PS60, all from Chr. Hansen® (Denmark). The coagulant was CHY-MAX® Plus from Chr. Hansen® (Denmark). The dosage of the coagulant was 110 IMCU/100 g of protein. The culture's dosage applied for 150 kg of milk are, respectively, 5 U, 0.93 U, 2.15 U and 3×10⁹ CFU. The milk composition is shows in the Table 1. In this case example, 1 g of particles with homogeneous size (5 μm) (Chr. Hansen®) were added by 100 L of milk, at the same moment as the cultures.

The maturation (from the culture add until cutting) step was 70 min at 32° C. and after that the curd was cut in 5 mm cubes. After cutting, the curd was pre-stirred for 5 minutes before whey off (−35%) and the stirring continue for 20 min before scalding at 40° C. The scalding took 20 min and after the curd was stirred for 40 min before pre-pressing step starts. The pH of the curd at whey-off was 6.63. After pre-pressing, the curd was moulded into 2 square cheeses of 7 kg each, followed by 3 pressing steps: 10 min at 2 bars, 20 min at 3.5 bar and 80 min at 5 bars. The pH at the end of the pressing was 5.44 (±0.02). The cheeses were brined for 16 hs in a brine containing 22% of salt and pH 5.2, with a salt-in-moisture target of 3%. After brining, the cheeses were packed in plastic bags (Sealed Air—68 μm—BB6050) and were transferred to the ripening rooms and followed a precise ripening cycle: 1 week at 9° C., 4 weeks at 20° C. (warm room), 4 weeks at 9° C., finishing at 5° C.

After the warm room, the cheeses were opened and analysed for overall composition (fat, protein, salt, pH), organic acids concentrations, as well eyes formation quality and distribution (visual evaluation, with measurement). To analyse the distribution of the eyes formation in the cheeses, the cheeses were opened precisely in the middle, 5 cm from the middle and 10 cm from the middle (FIG. 5).

The composition of the cheeses produced with this process is presented on Table 2.

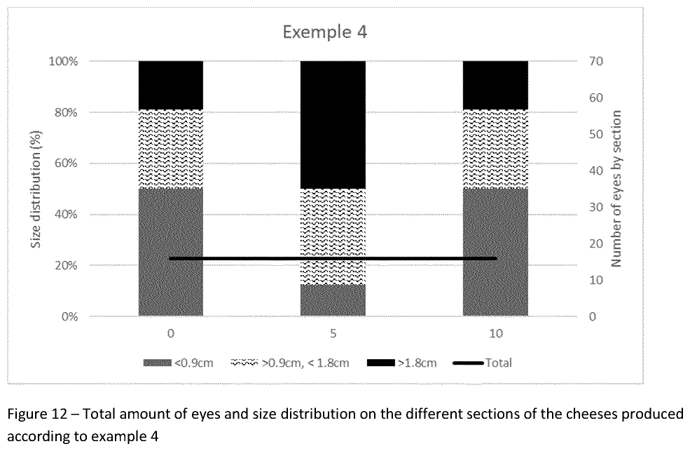

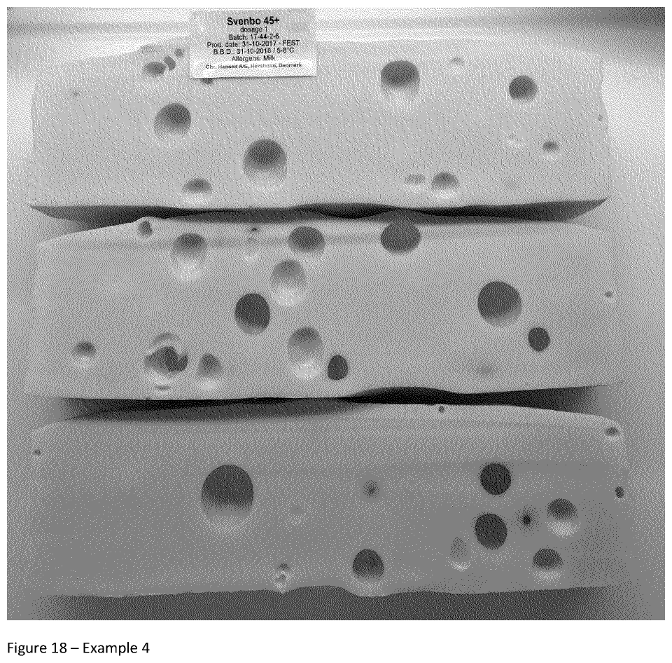

The distribution of the eyes formation is presented on FIG. 12 an FIG. 18. On each region of the cheese, the total number of eyes was counted, as well classified in 3 categories: eyes bigger than 1.8 cm, eyes between 0.9 and 1.8 cm and eyes smaller than 0.9 cm.

In this example, the total number of eyes formed on each section was uniform and low (around 16 by section), with a variable size profile between the sections. This lower number and higher heterogeneity were correlated to the lower dosage of nuclei applied.

This fourth example confirms the importance of the size uniformity of the particles applied on the quality of the eyes formed.

### Example 5

### Modern Cheesemaking Process for Propionic Cheeses Using Optimal Concentration of Controlled Particle Sizes to Improve Eyes Formation

This fifth example is a modern Propionic cheesemaking process according to the literature and industrial recipes were used (flow charts described in FIG. 4). For this example, the cultures used were DVS® C150, DVS® LHB02, DVS® STB-01 and DVS® PS60, all from Chr. Hansen® (Denmark). The coagulant was CHY-MAX® Plus from Chr. Hansen® (Denmark). The dosage of the coagulant was 110 IMCU/100 g of protein. The culture's dosage applied for 150 kg of milk are, respectively, 5 U, 0.93 U, 2.15 U and 3×10⁹ CFU. The milk composition is shows in the Table 1. In this case example, 2 g of particles with homogeneous size (5 μm) (Chr. Hansen®) were added by 100 L of milk, at the same moment as the cultures.

The maturation (from the culture add until cutting) step was 70 min at 32° C. and after that the curd was cut in 5 mm cubes. After cutting, the curd was pre-stirred for 5 minutes before whey off (−35%) and the stirring continue for 20 min before scalding at 40° C. The scalding took 20 min and after the curd was stirred for 40 min before pre-pressing step starts. The pH of the curd at whey-off was 6.63. After pre-pressing, the curd was moulded into 2 square cheeses of 7 kg each, followed by 3 pressing steps: 10 min at 2 bars, 20 min at 3.5 bar and 80 min at 5 bars. The pH at the end of the pressing was 5.44 (±0.02). The cheeses were brined during 16 hs in a brine containing 22% of salt and pH 5.2, with a salt-in-moisture target of 3%. After brining, the cheeses were packed in plastic bags (Sealed Air—68 μm—BB6050) and were transferred to the ripening rooms and followed a precise ripening cycle: 1 week at 9° C., 4 weeks at 20° C. (warm room), 4 weeks at 9° C., finishing at 5° C.

After the warm room, the cheeses were opened and analysed for overall composition (fat, protein, salt, pH), organic acids concentrations, as well eyes formation quality and distribution (visual evaluation, with measurement). To analyse the distribution of the eyes formation in the cheeses, the cheeses were opened precisely in the middle, 5 cm from the middle and 10 cm from the middle (FIG. 5).

The composition of the cheeses produced with this process is presented on Table 2.

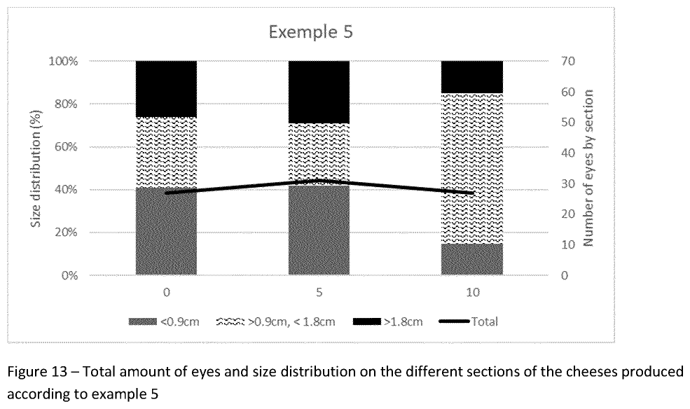

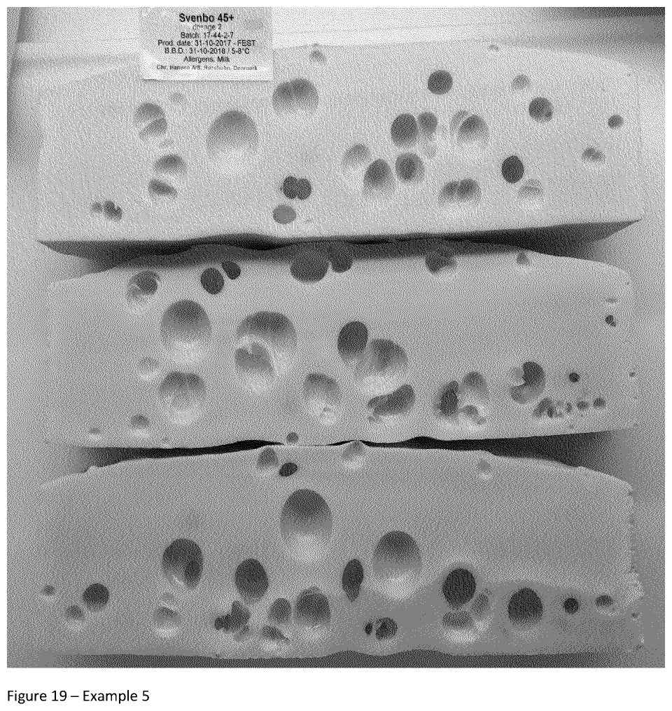

The distribution of the eyes formation is presented on FIG. 13 and FIG. 19. On each region of the cheese, the total number of eyes was counted, as well classified in 3 categories: eyes bigger than 1.8 cm, eyes between 0.9 and 1.8 cm and eyes smaller than 0.9 cm.

In this example, the total number of eyes formed is improved compared to example 4, with a better distribution (lower concentration of smaller eyes). This increase was correlated to the higher concentration of particles added, with a positive impact on the visual quality of the eyes.

This fifth example confirms the importance of the size uniformity of the particles applied on the quality of the eyes formed, as well the impact of the concentration applied.

### Example 6

### Production of Particulate Material Used in Example 4 and 5

Casein glycomacropeptide (CGMP) was purified from a commercial sample (Lacprodan CGMP-10, Arla Food Ingredients, Denmark). The dry matter contained around 85% protein of which about 73% was monomeric CGMP. Sodium caseinate was the bulk material used at Chr. Hansen (#500459/5092825). Microbial transglutaminase (mTG) was from Ajinomoto and it had an activity of 1000 U g⁻¹ of the powder as measured by colorimetric hydroxamate method. All other chemicals were of analytical grade. Calcium chloride dihydrate (CaCl₂.2H₂O) was procured from Sigma Aldrich. Disodium hydrogen phosphate dihydrate (Na₂HPO₄.2H₂O), sodium dihydrogen phosphate monohydrate (NaH₂PO₄.H₂O), and sodium carbonate (Na₂CO₃) were obtained from Merck. Filter Paper of diameter 320 mm (Whatman 114 V Filter Paper Cone, wet strengthened) was procured from GE Healthcare Life Sciences. MU-water (18.2 MΩ cm) was used for preparing all the solutions.

Polymerized casein glycomacropeptide (poly-CGMP) and polymerized sodium caseinate (poly-caseinate) were prepared by enzymatic crosslinking of the casein glycomacropeptide (CGMP) or sodium caseinate using microbial transglutaminase (mTG). The CGMP (120 g/L) or caseinate (30 g/L) powder was suspended in 0.2 M sodium phosphate buffer (pH 7.0). The CGMP suspension was heated at 90° C. for 30 minutes, and then cooled down on ice followed by centrifugation at 10000 g for 1 h to remove the insoluble matter. The supernatant from centrifuged solution was then vacuum filtered using a membrane of 0.22 μm pore size to obtain the soluble CGMP. Next, the soluble CGMP or the soluble caseinate was crosslinked using mTG at 40° C. with 2 U mL⁻¹ of enzyme dosage. After 30 h of incubation, the mTG was inactivated by heating the solution at 90° C. for 10 minutes, and subsequently cooled on ice.

The poly-CGMP stock solution was diluted to a concentration of 20 g/L using 0.52 M Na₂HPO₄. The poly-caseinate stock solution was diluted to a concentration of 10 g/L using 0.75 M Na₂CO₃. The microparticle preparation was carried out in two sequential steps. First, 100 mL of CaCl₂ (4.5 M) was added to 450 mL of poly-CGMP solution (20 g/L). The addition of CaCl₂ was done over a period of 10 minutes while the suspension was being stirred. Next, 450 mL of poly-caseinate (10 g/L) solution was added to the above suspension. The addition was done over a period of 10 minutes while the suspension was being continuously stirred. The suspension was stirred for 12 hours at room temperature (24±2° C.) and then filtered over a filter paper and wash with 2× volume of MQ-water i.e. using 2 L of MQ-water for 1 L of original suspension volume. The washed wet cake of coated microparticles was spread into a thin layer in the petri dish and then dried at 24±2° C. for 12 hours inside a laminar flow chamber. The dried microparticles were then grinded into a fine powder using mortar and pestle. The dry powder was kept in an air oven pre-heated at 85° C. for 1 h to remove any residual moisture as well as to sterilize and then it was stored in a sterile container. An alternative method to prepare the dry powder of inorganic-organic microparticles could be by spray drying.

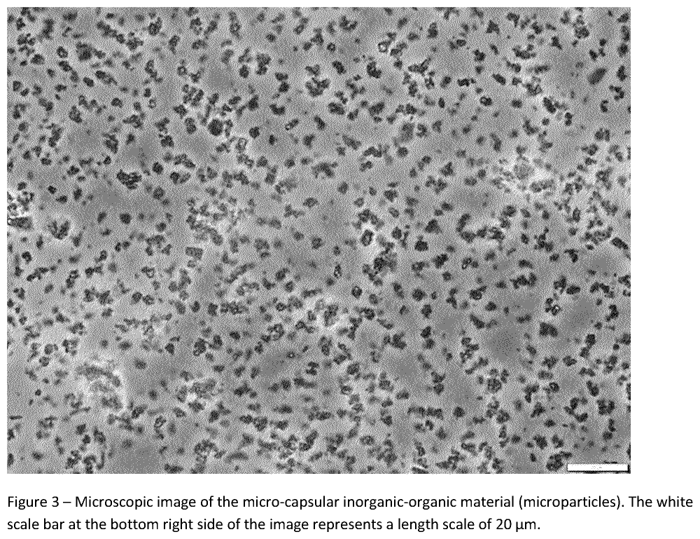

A drop of microparticle suspension (≈1 g/L) was placed on a glass slide and then covered with a glass cover-slip. The glass slide was viewed under the transmittance mode in an optical microscope (BX 53, Olympus) and 40× magnification (UPlan FL N, 40×/0.75 Ph2). The images were captured using a CCD camera (SC 50, Olympus) attached to the microscope. The image was captured using software supplied by Olympus (cellSens Entry, exposure: 5.027 ms). HQ color images with standard aspect ratio and a resolution of 2560×1920 were captured and labelled with a pre-calibrated scale (white bar=20 μm) as shown in FIG. 3.

### REFERENCES

R. K. Abrahamsen, O. Byre, K. Steinsholt, A. H. Strand, Jarlsberg Cheese history and development, Tun Forlag, As, Norway 2006

M. T. Fröhlich-Wyder, H. P. Bachmann, Cheeses with propionic acid fermentation, Cheese: Chemistry, Physics and Microbiology, Volume 2, 2004, Pages 141-xv

M. T. Fröhlich-Wyder, W. Bisig, D. Guggisbert, E. Jakob, M. Turgay, D. Wechslern, Cheese with propionic acid fermentation, Cheese, chemistry, physics&microbiology, Chapter 35, Fourth edition, volume 2, 2017, pages 889-928

Dominik Guggisberg, Philipp Schuetz, Hans Winkler, Rudolf Amrein, Daniel Wechsler, Mechanism and control of the eye formation in cheese, International Dairy Journal, Volume 47, August 2015, Pages 118-127

H. Kraggerud, J. P. Wold, M. Hoy, R. K. Abrahamsen, X-ray images for the control of eye formation in cheese. Int. J. Dairy Technol. 2009, 62, pages 147-153

Paul L. H. McSweeney, Giorgio Ottogalli, Patrick F. Fox, Diversity and Classification of Cheese Varieties: An Overview Chapter 31, Fourth edition, volume 2, 2017, Pages 781-808

U. Rehn, F. K. Vogensen, S. -E. Persson, K. Hallin Saedén, Y. Ardö, Influence of microflora on texture and contents of amino acids, organic acids, and volatiles in semi-hard cheese made with DL-starter and propionibacteria, Journal of Dairy Science, Volume 94, Issue 3, March 2011, Pages 1098-1111

R. Richoux, J. R. Kerjean, 1995, Technological properties of pure propioni-bacteria strain: test in small Swiss-type cheeses. Lait 75, 45-59

R. Richoux, E. Faivre, J. R. Kerjean, 1998, Effect of NaCl content on lactate fermentation by Propionibacterium freudenreichii in small scale Swiss-type cheeses. Lait 78, 319-331

L. Mato Rodriguez, T. Ritvanen, V. Joutsjoki, J. Rekonen, T. Alatossava, The role of copper in the manufacture of Finnish Emmental cheese, Journal of Dairy Science, Volume 94, Issue 10, October 2011, Pages 4831-4842

S. Roustel, A. Sperat-Czar, D. Pereira, Cheese ripening guide, Edition Profession Fromager, 2017.

Anne Thierry, Stephanie-Marie Deutsch, Hélène Falentin, Marion Dalmasso, Gwenaél Jan, New insights into physiology and metabolism of Propionibacterium freudenreichii, International Journal of Food Microbiology, Volume 149, Issue 1, 1 Sep. 2011, Pages 19-27

1. A process for making cheese, the process comprising:
a. Obtaining a milk composition
b. Optionally maturing said milk composition by physical, chemical or biological means
c. Adding particles with a size of 1 μm to 50 μm to said milk composition
d. Adding lactic acid bacteria and/or proprionic bacteria
e. Adding coagulant,
wherein steps c, d, and e may be done in random order, sequentially or simultaneously
f. and further processing the composition to produce a cheese.

2. A process according to claim 1 wherein the cheese is a Swiss type or continental type cheese.

3. A process according to any of the preceding claims wherein the particles with a size of 1 μm to 50 μm is added in an amount of 0.5 g to 5 g per liter milk, such as e.g. 1 g to 3 g per liter milk.

4. A process according to any of the preceding claims wherein the particles is added as a dried powder, frozen powder or resuspended powder.

5. A process according to any of the preceding claims wherein the size of the particles has an average diameter from 1 μm to 30 μm, such as e.g. 3-20 μm, such as e.g. 5 μm

6. A process according to any of the preceding claims wherein the particles with a size of 1 μm to 50 μm contains a compound selected from the list consisting of: micellar casein, casein glycomacropeptide (CGMP), polymerized casein glycomacropeptide (pCGMP), sodium caseinate or poly caseinate.

7. A process according to any of the preceding claims wherein the milk composition has a fat content of from 1% to 5%, such as e.g. around 2% to 4%, such as e.g. around 3%.

8. A process according to any of the preceding claims wherein the milk composition has a protein content of from 1% to 5%, such as e.g. around 2% to 4%, such as e.g. around 3%.

9. A process according to any of the preceding claims wherein the lactic acid bacteria are selected from a list comprising: Lactococcus lactis subsp. cremoris and Lactococcus lactis subsp lactis, Lactobacillus helveticus, Streptococcus thermophilus and/or the proprionic acid bacteria is selected from Propionibacterium freudenreichii such as Propionibacterium freudenreichii subsp freudenreichii.

10. A process according to any of the preceding claims wherein the coagulant is of microbial origin or animal origin, such as bovine or camel origin.

11. Use of particles having an average diameter of 1 μm to 50 μm, such as e.g. 3 μm to 30 μm for making cheese.

12. Use according to claim 11 wherein the particles are added as a dried powder, frozen powder or resuspended powder.

13. Use according to any of claim 11 or 12, wherein the size of the particles has an average diameter from 1 μm to 30 μm, such as e.g. 3 to 20 μm, such as e.g. 5 μm.

14. Use according to any of claim 11 or 12 wherein the particles with a size of 1 μm to 50 μm contains a compound selected from the list consisting of: micellar casein, casein glycomacropeptide (CGMP), polymerized casein glycomacropeptide (pCGMP), sodium caseinate or poly caseinate.

15. Use according to any of claims 11 to 14 in a process according to any of claims 1 to 10.

16. A cheese produced by a process according to any of claims 1 to 10.

17. A composition comprising particles with a size of 1 μm to 50 μm, lactic acid bacteria and optionally proprionic bacteria.

18. A composition according to claim 17 further comprising a coagulant.

19. A composition according to any claim 17 or 18 wherein the size of the particles has an average diameter from 1 μm to 30 μm, such as e.g. 3-20 μm, such as e.g. 5 μm.

20. A composition according any of claims 17 to 19 wherein the particles with a size of 1 μm to 50 μm contains a compound selected from the list consisting of: micellar casein, casein glycomacropeptide (CGMP), polymerized casein glycomacropeptide (pCGMP), sodium caseinate or poly caseinate.

21. A composition according to any of claims 17 to 20 wherein the lactic acid bacteria are selected form a list comprising: Lactococcus lactis subsp. cremoris and Lactococcus lactis subsp lactis, Lactobacillus helveticus, Streptococcus thermophilus.

22. A composition according to any of claims 17 to 21 wherein the proprionic acid bacteria are Propionibacterium freudenreichii such as e.g. Propionibacterium freudenreichii subsp freudenreichii.

23. A composition according to any of claims 17 to 22 wherein the composition is frozen or freeze dried.
